(19) United States
(12) Patent Application Publication
(10) Pub. No.: US 2026/0004248 A1
(43) Pub. Date: Jan. 1, 2026

(54) SYSTEMS AND METHODS FOR SEMANTIC CONTENT GENERATION

(71) Applicant: WORKDAY, INC., Pleasanton, CA (US)

(72) Inventors: Connor MACNULTY, Dublin, CA (US); Auzeb MANZOOR, Nova Scotia (CA); Huan HO, North Vancouver (CA); Sam GUMMESON, Ottawa (CA); Reyhan JHAVER, Vallejo, CA (US)

(21) Appl. No.: 18/757,679

(22) Filed: Jun. 28, 2024

(51) Int. Cl. G06Q 10/1053; G06F 40/30; G06Q 10/0631; G06Q 10/0639

(52) U.S. Cl. CPC G06Q 10/1053; G06F 40/30; G06Q 10/063112

(57) ABSTRACT

In some implementations, the techniques described herein relate to a method including: issuing, by a computing device, a query to a database; receiving, at the computing device, a response to the query that includes first natural language data associated with a set of users and second natural language data including textual data; augmenting, by the computing device, the first natural language data using a first machine learning model to generate a set of augmented profiles for the set of users; augmenting, by the computing device, the second natural language data using a second machine learning model to generate a set of augmented textual data; generating, by the computing device, a difference between the set of augmented profiles and the set of augmented textual data using a third machine learning model; and transmitting, by the computing device, a visualization of an output from the third machine learning model.

### BACKGROUND

In an era of burgeoning information repositories, extracting meaningful information from an information repository is an increasingly formidable task. Given the sheer volume of data included in many databases, extracting meaningful insights from the data may be a difficult or impossible feat to accomplish manually. As such, there exists a need for computerized models that can analyze data from large data repositories to generate semantic content.

### BRIEF DESCRIPTION OF THE FIGURES

FIG. 1 is a flow diagram of an exemplary method for augmenting natural language data.

FIG. 2 is a block diagram of an exemplary system for augmenting natural language data.

FIG. 3 is an additional block diagram of a data flow for augmenting natural language data.

FIG. 4 is a block diagram of a computing device according to some embodiments of the disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION

The disclosed embodiments relate to a system for augmenting natural language data using machine learning models to generate semantic content. In some examples, the system may receive (1) natural language data relating to users (e.g., an entity's employees), (2) natural language data relating to open job postings (e.g., the entity's open job postings), and/or (3) natural language labor market data. Then, the system may use a machine learning model to augment the natural language data (e.g., augmenting the data relating to the users to generate a set of augmented skills profiles for the users, augmenting the open job postings data to generate a set of augmented job postings, and/or augmenting the labor market data to generate a set of augmented labor market skills). In some examples, the system may use a machine learning model to determine a difference between two or more of the augmented data sets. An output from this machine learning model (e.g., an output generated based on the determined difference) may be transmitted as a digital visualization.

In some implementations, the techniques described herein relate to a method including: issuing, by a computing device, a query to a database; receiving, at the computing device, a response to the query, the response including first natural language data including textual data associated with a plurality of users and second natural language data including textual data (e.g., describing open job postings); augmenting, by the computing device, the first natural language data using a first machine learning model to generate a set of augmented profiles (e.g., augmented skills profiles) for the plurality of users; augmenting, by the computing device, the second natural language data using a second machine learning model to generate a set of textual data (e.g., a set of augmented job postings); generating, by the computing device, a difference between the set of augmented profiles (e.g., augmented skills profiles) and the set of augmented textual data (e.g., the set of augmented job postings) using a third machine learning model; and transmitting, by the computing device, a visualization of an output from the third machine learning model.

In some implementations, the techniques described herein relate to the method of 1, further including: receiving, at the computing device, third natural language data including additional textual data (e.g., textual labor market data); augmenting, by the computing device, the third natural language data to generate an additional set of augmented textual data (e.g., a set of augmented labor market skills); and generating, by the computing device using the third machine learning model, a difference between at least one of: the set of augmented profiles and the additional set of augmented textual data; or the set of augmented textual data and the additional set of augmented textual data.

In some implementations, the techniques described herein relate to a method, wherein the first natural language data includes at least one of: a user job description; user-generated content; a description of a learning course completed by a user; or a description of a project completed by a user.

In some implementations, the techniques described herein relate to a method, further including extracting the first natural language data, by the computing device, from at least one of: a digital user profile; a digital user resume; a digital user certificate; a digital user record; or a digital project record.

In some implementations, the techniques described herein relate to a method, wherein the output includes a semantic skills insight.

In some implementations, the techniques described herein relate to a method, wherein the semantic skills insight includes at least one of: a semantic insight relating to a skill covered by a current workforce; a semantic insight relating to a level of proficiency in a skill covered by the current workforce; a semantic insight relating to a skills gap corresponding to a skill that is not covered by the current workforce; a summary of skills corresponding to jobs being recruited via the open job postings; a summary of skills that the current workforce is losing via attrition; a summary of how specific skills are represented in the current workforce; a suggestion for transitioning the current workforce from a current set of skills to a new set of skills; or a summary of skills-based industry hiring trends.

In some implementations, the techniques described herein relate to a method, wherein: the first natural language data includes data associated with a specific user within the plurality of users; and the output from the third machine learning model includes a semantic insight relating to the specific user.

In some implementations, the techniques described herein relate to a method, wherein the semantic insight relating to the specific user relates to at least one of: one or more skills of the specific user; a job history of the specific user; a current job corresponding to the specific user; one or more skills areas where the specific user is weak according to a skills metric; or one or more learning courses completed by the specific user.

In some implementations, the techniques described herein relate to a method, wherein the one or more skills of the specific user include at least one of: a current skill of the specific user; a skill that the specific user lacks; or a skill predicted to be beneficial for the user to obtain.

In some implementations, the techniques described herein relate to a method, further including generating the third machine learning model based on the first natural language data and the second natural language data.

In some implementations, the techniques described herein relate to a non-transitory computer-readable storage medium for tangibly storing computer program instructions capable of being executed by a computer processor, the computer program instructions defining steps of: issuing a query to a database; receiving a response to the query, the response including first natural language data including textual data associated with a plurality of users and second natural language data including textual data describing open job postings; augmenting the first natural language data using a first machine learning model to generate a set of augmented skills profiles for the plurality of users; augmenting the second natural language data using a second machine learning model to generate a set of augmented job postings; generating a difference between the set of augmented skills profiles and the set of augmented job postings using a third machine learning model; and transmitting a visualization of an output from the third machine learning model.

In some implementations, the techniques described herein relate to a non-transitory computer-readable storage medium, the computer program instructions further defining steps of: receiving third natural language data including textual labor market data; augmenting the third natural language data to generate a set of augmented labor market skills; and generating a difference between at least one of: the set of augmented skill profiles and the set of augmented labor market skills; or the set of augmented job postings and the set of augmented labor market skills.

In some implementations, the techniques described herein relate to a non-transitory computer-readable storage medium, wherein the first natural language data includes at least one of: a user job description; user-generated content; a description of a learning course completed by a user; or a description of a project completed by a user.

In some implementations, the techniques described herein relate to a non-transitory computer-readable storage medium, the computer program instructions further defining steps of extracting the first natural language data from at least one of: a digital user profile; a digital user resume; a digital user certificate; a digital user record; or a digital project record.

In some implementations, the techniques described herein relate to a non-transitory computer-readable storage medium, wherein the output includes a semantic skills insight.

In some implementations, the techniques described herein relate to a non-transitory computer-readable storage medium, wherein the semantic skills insight includes at least one of: a semantic insight relating to a skill covered by a current workforce; a semantic insight relating to a level of proficiency in a skill covered by the current workforce; a semantic insight relating to a skills gap corresponding to a skill that is not covered by the current workforce; a summary of skills corresponding to jobs being recruited via the open job postings; a summary of skills that the current workforce is losing via attrition; a summary of how specific skills are represented in the current workforce; a suggestion for transitioning the current workforce from a current set of skills to a new set of skills; or a summary of skills-based industry hiring trends.

In some implementations, the techniques described herein relate to a non-transitory computer-readable storage medium, wherein: the first natural language data includes data associated with a specific user within the plurality of users; and the output from the third machine learning model includes a semantic insight relating to the specific user.

In some implementations, the techniques described herein relate to a non-transitory computer-readable storage medium, wherein the semantic insight relating to the specific user relates to at least one of: one or more skills of the specific user; a job history of the specific user; a current job corresponding to the specific user; one or more skills areas where the specific user is weak according to a skills metric; or one or more learning courses completed by the specific user.

In some implementations, the techniques described herein relate to a non-transitory computer-readable storage medium, wherein the one or more skills of the specific user include at least one of: a current skill of the specific user; a skill that the specific user lacks; or a skill predicted to be beneficial for the user to obtain.

In some implementations, the techniques described herein relate to a device including: a processor; and a storage medium for tangibly storing thereon program logic for execution by the processor, the program logic including: logic, executed by the processor, for issuing a query to a database, logic, executed by the processor, for receiving a response to the query, the response including first natural language data including textual data associated with a plurality of users and second natural language data including textual data describing open job postings, logic, executed by the processor, for augmenting the first natural language data using a first machine learning model to generate a set of augmented skills profiles for the plurality of users, logic, executed by the processor, for augmenting the second natural language data using a second machine learning model to generate a set of augmented job postings; logic, executed by the processor, for generating a difference between the set of augmented skills profiles and the set of augmented job postings using a third machine learning model; and logic, executed by the processor, for transmitting a visualization of an output from the third machine learning model.

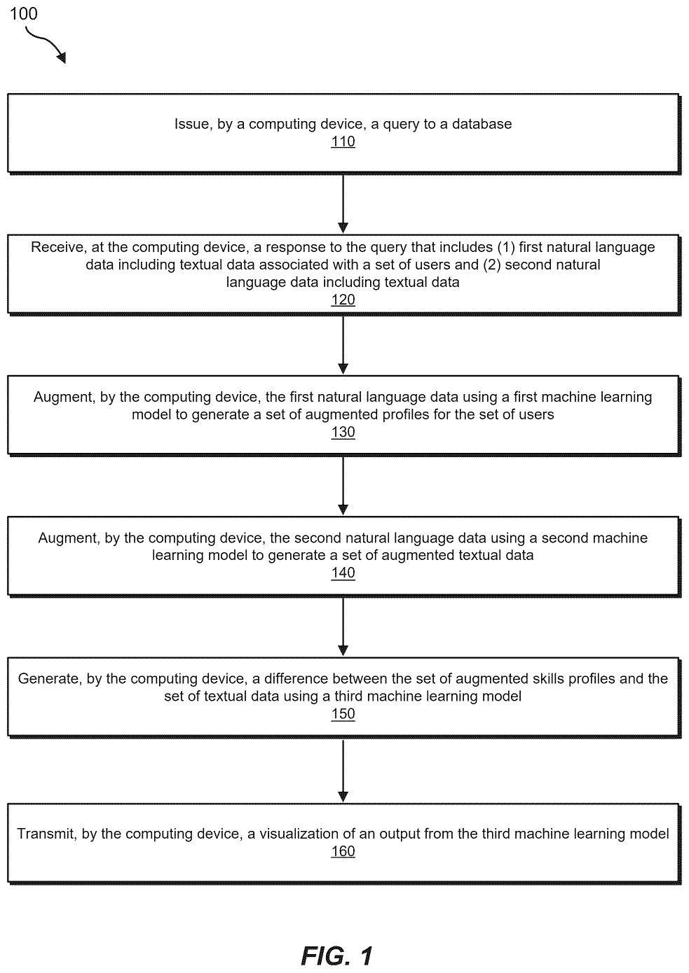

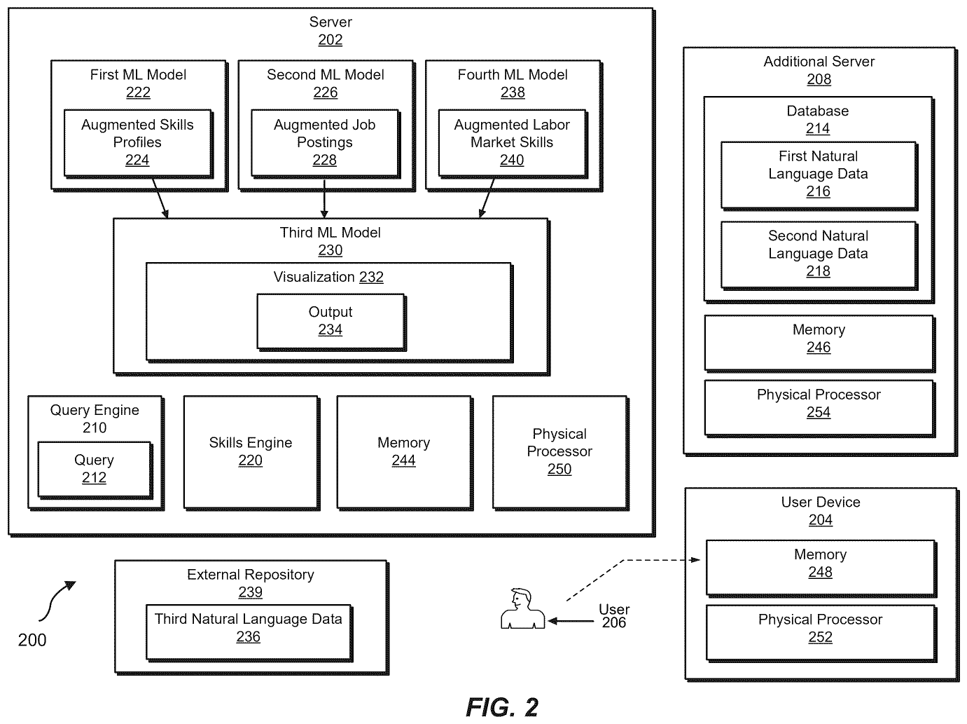

FIG. 1 is a flow diagram of an exemplary method 100. The steps shown in FIG. 1 may be performed by any suitable computer-executable code and/or computing system, including the system(s) illustrated in FIG. 2. For example, the steps shown in FIG. 1 may be performed by modules operating in a server 202, modules operating in a user device 204 (associated with a user 206), and/or modules operating in an additional server 208. In one example, each of the steps shown in FIG. 1 may represent an algorithm whose structure includes and/or is represented by multiple sub-steps, examples of which will be provided in greater detail below.

Server 202 and additional server 208 may each generally represent any type or form of backend computing device capable of reading computer-executable instructions (e.g., that may perform one or more functions directed at data storage, data extraction, data augmentation, and/or automated data analysis). User device 204 generally represents any type or form of computing device capable of reading computer-executable instructions (e.g., a device that can receive and/or execute a software application) communicatively coupled to server 202 and/or additional server 208. Examples of user device 204 may include, without limitation, a laptop, a desktop, a wearable device, a smart phone, a tablet, a personal digital assistant (PDA), etc.

In one example, server 202 may be configured to receive data from a database stored on additional server 208 and perform one or more steps on the data received from additional server 208. In some examples, user device 204 is described as a computing device that communicates over a network with a skills insight software application via a skills insight system (e.g., operating as part of server 202). In one example, the skills insight software application can comprise a software-as-a-service (SaaS) application, and user device 204 may comprise a personal computing device, associated with a user 206, accessing the software application via a web browser or dedicated mobile application. In some examples, not depicted in FIG. 2, server 202 may extract data from a database stored at server 202.

At step 110 of FIG. 1, one or more of the systems described herein may issue, by a computing device, a query to a database. For example, as illustrated in FIG. 2, a query engine 210 may issue, by server 202, a query 212 to a database 214. In some examples, (1) database 214 may be stored on additional server 208 and (2) query engine 210 may be implemented as software executing on server 202 or distributed across multiple servers (e.g., server 202 and additional server 208). In these examples query engine 210 may query database 214 by transmitting query 212 to additional server 208. In other examples, database 214 may be stored on server 202 and query engine 210 may be implemented as software executing on server 202. In these examples, query engine 210 may query database 214 directly (e.g., by interfacing with an Application Programming Interface (API) of database 214).

Query engine 210 may issue query 212 in response to a variety of triggers. In some examples, query engine 210 may issue query 212 in response to receiving a user request (e.g., from user 206 via user device 204). Additionally or alternatively, query engine 210 may issue query 212 at a designated time and/or at designated intervals (e.g., as part of a scheduled data analysis process).

Query engine 210 may issue query 212 using any designated communication protocol and query 212 may represent any type or form of query. In some examples, database 214 may represent a Structured Query Language (SQL) database and query 212 may represent an SQL query. Additionally or alternatively, database 214 may represent a Not Only SQL (NoSQL) database and query 212 may represent an NoSQL query.

Query engine 210 may query for information using any query approach. In some examples, query 212 may specify specific data repositories within database 214 from which to extract data. Additionally or alternatively, query 212 may include a query for data that includes certain key words, data associated with certain entities (e.g., a query for data associated with an entity's employees), and/or specific types of data (e.g., user resumes, user job descriptions, employee-generated content, user certificates, etc.).

At step 120 of FIG. 1, one or more of the systems described herein may receive, at the computing device, a response to the query, which may include (1) first natural language data that includes textual data associated with a set of users and (2) second natural language data that includes textual data (e.g., textual data describing open job postings). For example, as illustrated in FIG. 2, a query engine 210 may receive, at server 202, a response to query 212, which may include (1) first natural language data 216 and (2) second natural language data 218.

First natural language data 216 may refer to any type or form of textual data, written in human language, that is associated with a set of users (e.g., a set of employees employed by an entity). In certain examples, first natural language data 216 may represent unstructured data. In some examples, first natural language data 216 may include data (e.g., all data) stored within database 214 that is associated with the set of users (e.g., data tagged with a user tag, data in designated data repositories associated with users in the set of users, data that includes key words associated with users in the set of users, etc.). In some examples, first natural language data 216 may include natural language data associated with user skills (e.g., natural language data that explicitly describes an employee skill) and/or natural language data from which a user skill can be inferred (e.g., using a machine learning model). In some such examples, an extraction engine may be configured to extract, from database 214, only data that is associated with user skills. In other examples, (1) an extraction engine may be configured to extract general data associated with the set of users (e.g., which may include both data associated with user skills and data that is not associated with user skills) and (2) the extracted data may be applied to a machine learning model (e.g., a model with one or more of the features described at steps 130 and 140), which may differentiate between skills-relevant data and skills-irrelevant data, outputting the skills-relevant data in response to receiving the extracted data as an input. First natural language data 216 may include a variety of types of content (e.g., an employee job description, employee-generated content, a description of a learning course completed by an employee, a description of a project completed by an employee, etc.). First natural language data 216 may be extracted from a variety of digital sources (e.g., digital repositories and/or types of digital documents). Examples of such sources include, without limitation, a digital employee profile, a digital employee resume, a digital employee certificate, a digital employee record, an educational record (e.g., a certification), and/or a digital project record.

Second natural language data 218 may refer to any type or form of textual data, written in human language, that describes open job postings. In some examples, second natural language data 218 may describe job posting posted by an entity associated with the set of users corresponding to first natural language data 216 (e.g., an employer-entity employing the set of users). In certain examples, second natural language data 218 may represent unstructured data. In some examples, second natural language data 218 may include data (e.g., all data) within database 214 associated with a job posting (e.g., data tagged with a job posting tag, data in a data repository designated for job postings, data that includes key words associated with job postings, etc.). In some examples, second natural language data 218 may include natural language data associated with user skills (e.g., natural language data that explicitly describes an employee skill desired for a job posting) and/or natural language data from which a user skill can be inferred. As was described in connection with the description of first natural language data 216, second natural language data 218 may be extracted via an extraction engine (e.g., which may be configured to extract skills-relevant and/or which may operate in connection with a machine learning model, as described in connection with the description of first natural language data 216).

At step 130 of FIG. 1 (e.g., upon receiving the response to the query), one or more of the systems described herein may augment, by the computing device, the first natural language data using a first machine learning model to generate a set of augmented profiles (e.g., augmented skills profiles) for the set of users. For example, as illustrated in FIG. 2, a skills engine 220 may augment, at server 202, first natural language data 216 using a first machine learning (ML) model 222, to generate a set of augmented skills profiles 224 for the set of users described at steps 110 and 120.

First ML model 222 may represent any type or form of computational model configured to augment natural language date (e.g., to generate augmented skills profiles). In some examples, first ML model 222 may represent a predictive model. Additionally or alternatively, first ML model 222 may represent a representative model. First ML model 222 may be generated (e.g., trained) using any type or form of machine learning technique. Such techniques may include, without limitation, supervised learning (e.g., via linear regression, a decision tree, a support vector machine, etc.), unsupervised learning (e.g., via k-means clustering, principal component analysis, etc.), and/or deep learning (e.g., via a convolutional neural network, a recurrent neural network, etc.). In some examples, first ML model 222 may represent a Natural Language Processing (NLP) model and/or a generative model. In certain examples, first ML model 222 may be generated by taking (e.g., generating) a basic model (e.g., a model generated using a general data set of skills extracted across one or more industries) and then training the basic model using entity-specific (e.g., employer-specific) data, such as first natural language data 216 and/or second natural language data 218. Additionally or alternatively, first ML model 222 may include both a basic model, which may be applied across multiple employer-entities, and an employer-entity-specific model (e.g., trained using a specific employer-entity's data). In other examples, first ML model 222 may operate in conjunction with a basic model.

Augmented skills profiles 224 may represent any type or form of data structure, received as an output from a machine learning model, that includes data relating to user skills. In some examples, augmented skills profiles may be organized by user (e.g., where each user in the set of users described at steps 110-120 has a distinct profile with skills information corresponding to the user). Each of these augmented skills profile may include a variety of data. In some examples, an augmented skills profile may include a list of skills corresponding to a user. For example, an augmented skills profile for a user may include skills that the user is determined to have, skills that are determined to be a natural fit for the user to acquire (e.g., as defined by an ease-of-skill-acquisition metric and/or an acquisition-benefit metric) and/or skills that the user does not have. In some examples, an augmented skills profile may include data indicating a level of proficiency in a skill as defined by a proficiency metric. In one such example, the level of proficiency may be determined based at least in part on a skill duration metric (e.g., indicating a date at which a skill was first acquired by a user and/or a latest date at which a skill is mentioned in connection with the user within first natural language data 216).

In some examples, skills engine 220 may augment first natural language data 216, using first ML model 222, by generating an aggregated skills profile for a workforce corresponding to the set of users and/or a subset of the set of users. The aggregated skills profile may include a variety of data including, without limitation, skills that are well covered by the workforce (e.g., as defined by a skills-coverage metric), skills that are not covered and/or not well covered by the workforce (e.g., as defined by the skills-coverage metric), and/or skills that would be easy for the workforce to develop with its existing users (e.g., as defined by an ease-of-skill-acquisition metric and/or an acquisition-benefit metric)

At step 140 of FIG. 1, one or more of the systems described herein may augment, by the computing device, the second natural language data using a second machine learning (ML) model to generate a set of augmented textual data (e.g., a set of augmented job postings). For example, as illustrated in FIG. 2, skills engine 220 may augment, at server 202, second natural language data 218 using a second ML model 226 to generate a set of augmented job postings 228.

Second ML model 226 may represent any type or form of computational model configured to augment natural language data (e.g., to generate augmented job postings). In some examples, second ML model 226 may represent a predictive model. Additionally or alternatively, second ML model 226 may represent a representative model. Second ML model 226 may be generated (e.g., trained) using any type or form of machine learning technique. Such techniques may include, without limitation, supervised learning (e.g., via linear regression, a decision tree, a support vector machine, etc.), unsupervised learning (e.g., via k-means clustering, principal component analysis, etc.), and/or deep learning (e.g., via a convolutional neural network, a recurrent neural network, etc.). In some examples, second ML model 226 may represent a Natural Language Processing (NLP) model and/or a generative model. In certain examples, second ML model 226 may be generated by first taking (e.g., generating) a basic model (e.g., a model generated using a general data set of skills extracted across one or more industries) and training the basic model using entity-specific (e.g., employer-specific) data, such as first natural language data 216 and/or second natural language data 218. Additionally or alternatively, second ML model 226 may include both a basic model, which may be applied across multiple employer-entities, and an employer-entity-specific model (e.g., trained using a specific employer-entity's data). In other examples, second ML model 226 may operate in conjunction with a basic model. Augmented job postings 228 may represent any type or form of data structure that includes skills indicated by second natural language data 218 (e.g., described in the job postings of second natural language data 218) and/or inferred from second natural language data 218 (e.g., via a machine learning model such as second ML model 226). In some examples, augmented job postings 228 may represent or include a list of skills that an entity, associated with the job postings of second natural language data 218, is trying to hire (e.g., via the job postings).

At step 150 of FIG. 1, one or more of the systems described herein may generate, by the computing device, a difference between the set of augmented profiles (e.g., augmented skills profiles) and the set of augmented textual data (e.g., the set of augmented job postings) using a third machine learning (ML) model. For example, as illustrated in FIG. 2, skills engine 220 may generate, at server 202, a difference between augmented skills profiles 224 and augmented job postings 228 using a third ML model 230.

Third ML model 230 may represent any type or form of computational model configured to augment natural language date (e.g., to generate augmented skills profiles). In some examples, third ML model 230 may represent a predictive model. Additionally or alternatively, third ML model 230 may represent a representative model. Third ML model 230 may be generated (e.g., trained) using any type or form of machine learning technique. Such techniques may include, without limitation, supervised learning (e.g., via linear regression, a decision tree, a support vector machine, etc.), unsupervised learning (e.g., via k-means clustering, principal component analysis, etc.), and/or deep learning (e.g., via a convolutional neural network, a recurrent neural network, etc.). In some examples, third ML model 230 may represent a Natural Language Processing (NLP) model and/or a generative model. In certain examples, third ML model 230 may be generated by first taking (e.g., generating) a basic model (e.g., a model generated using a general data set of skills extracted across one or more industries) and training the basic model using entity-specific (e.g., employer-specific) data, such as first natural language data 216 and/or second natural language data 218. Additionally or alternatively, third ML model 230 may include both a basic model, which may be applied across multiple employer-entities, and an employer-entity-specific model (e.g., trained using a specific employer-entity's data). In other examples, third ML model 230 may operate in conjunction with a basic model. In certain examples, third ML model 230 may include or operate in connection with first ML model 222 and/or second ML model 226.

In some examples, the disclosed method may include generating (e.g., building) third ML model 230. In these examples, third ML model 230 may be generated in a variety of ways. In some examples, third ML model 230 may be generated based on outputs from first ML model 222, second ML model 226, and/or a fourth machine learning (ML) model 238 (which will be described later in greater detail). In certain examples, third ML model 230 may be generated by first generating a basic model using a general data set of skills extracted across one or multiple industries (e.g., a data set that includes semantic descriptions of tens of thousands of skills). In some such examples, the general data set may represent general labor market data and/or an output from a machine learning model (e.g., fourth ML model 238) that was trained using general labor market data. Then, the basic model may be trained (e.g., via a combination of supervised and unsupervised learning) using employer-specific data (e.g., data for a specific employer-entity) extracted from an employer database (e.g., first natural language data 216, second natural language data 218, and/or outputs from first ML model 222 and/or second ML model 226) and/or a data repository of data relating to an industry relating to an employer (e.g., extracted from a curated data repository and/or the Internet via a web crawler).

The difference between augmented skills profiles 224 and augmented job postings 228 may be delineated in a variety of ways. In some examples, the difference may be delineated as a list of skills (e.g., described in augmented job postings 228) that the set of workers does not have covered (e.g., skills that are not covered by the skills described in augmented skills profiles 224), according to a skills-coverage metric (e.g., a skill that no users have or fewer than a designated number of users have), and/or skills that the set of workers does have covered according to the skills-coverage metric. In some examples, skills engine 220 may additionally generate a list of users who could acquire one or more of the skills that the workforce does not have covered (e.g., according to an ease-of-skill-acquisition metric as described at step 130).

At step 160 of FIG. 1, one or more of the systems described herein may transmit, by the computing device, a visualization of an output from the third machine learning model. For example, as illustrated in FIG. 2, skills engine 220 may transmit (e.g., from server 202 to user device 204) a visualization 232 of an output 234 from third ML model 230. Output 234 visualized in visualization 232 may correspond to a variety of content. In some examples, output 234 may correspond to the difference between augmented skills profiles 224 and augmented job postings 228 generated at step 150. Additionally or alternatively, output 234 may correspond to a semantic skills insight (e.g., generated based on augmented skills profiles 224, augmented job postings 228, and/or the difference between augmented skills profiles 224 and augmented job postings 228). Examples of such semantic skills insights may include, without limitation, a semantic insight relating to a skill covered by a current workforce (e.g., by the set of users), a semantic insight relating to a level of proficiency in a skill covered by the current workforce, a semantic insight relating to a skill gap corresponding to a skill that is not covered by the current workforce (e.g., as defined by a skill-coverage metric), a summary of skills corresponding to jobs being recruited via the open job postings, a summary of skills that the current workforce is losing via attrition (e.g., as defined by an attrition metric), a summary of how specific skills are represented in the current workforce, a suggestion for transitioning the current workforce from a current set of skills to a new set of skills, and/or a summary of skills-based industry hiring trends. In some examples, visualization 232 may include a temporal depiction, showing how a semantic insight changes over time (e.g., showing how skills of a workforce change over time).

Visualization 232 may take any digital form (e.g., may represent any content configured to be displayed within a graphical user interface via a display element of a computing device). Examples of visualization 232 include, without limitation, a report, a chart, a graph, a dashboard, a graphic, a diagram, and/or an infographic.

While the description above focuses on an embodiment that relies on natural language data relating to a set of users and/or job postings, it should be appreciated that the disclosed systems may be implemented in connection with any type of natural language data (e.g., extracted from any type of data repository). For example, in some examples, skills engine 220 may (e.g., at step 120 in response to issuing a query at step 110) receive third natural language data 236 that includes textual labor market data (e.g., data extracted from a data repository that is external to database 214 such as external repository 239). In these examples, third natural language data 236 may be received from a variety of data repositories. For example, third natural language data 236 may be received from the Internet (e.g., via a web crawler) and/or a database of labor market data (e.g., curated for the disclosed systems and/or maintained in association with server 202). Then, skills engine 220 may augment third natural language data 236, using fourth ML model 238 to generate a set of augmented labor market skills 240.

Fourth ML model 238 may represent any type or form of computational model configured to augment natural language data (e.g., to generate a set of augmented labor market skills). In some examples, fourth ML model 238 may represent a predictive model. Additionally or alternatively, fourth ML model 238 may represent a representative model. Fourth ML model 238 may be generated (e.g., trained) using any type or form of machine learning technique. Such techniques may include, without limitation, supervised learning (e.g., via linear regression, a decision tree, a support vector machine, etc.), unsupervised learning (e.g., via k-means clustering, principal component analysis, etc.), and/or deep learning (e.g., via a convolutional neural network, a recurrent neural network, etc.). In some examples, fourth ML model 238 may represent a Natural Language Processing (NLP) model and/or a generative model.

In some such examples, skills engine 220 may rely on augmented labor market skills 240 to generate one or more skills insights (e.g., received as an output from third ML model 230 in response to applying augmented labor market skills 240 as an input to third ML model 230), which may be visualized in visualization 232. For example, skills engine 220 may (1) generate (e.g., using third ML model 230) a difference between set of augmented skills profiles 224 and augmented labor market skills 240 and (2) generate a skills insight based on the generated difference (e.g., a skills insight indicating a gap between the skills of the set of users and the skills in a labor market corresponding to the set of users, etc.). As another examples, skills engine 220 may (1) generate (e.g., using third ML model 230) a difference between augmented job postings 228 and augmented labor market skills 240 and (2) generate a skills insight based on the generated difference (e.g., a skills insight indicating a difference between the types of skills an entity associated with database 214 is hiring for and skills that are relevant to an industry corresponding to the entity).

In some examples, the disclosed systems and methods may be used to generate semantic insights relating to a specific user. In some such examples, first natural language data 216 may include data associated with the specific user and output from third ML model 230 may include a semantic insight relating to the specific user. In other such examples, third ML model 230 may be built (e.g., generated) using outputs from first ML model 222 and/or second ML model 226 and the specific user's data may be applied to third ML model 230 after third ML model 230 has been built using the outputs from first ML model 222 and/or second ML model 226. The one or more semantic insights associated with the specific user may be visualized within visualization 232 and/or a subsequent visualization. The one or more semantic insights associated with the specific user may include any type or form of semantic insight. Examples of such a semantic insight may include, without limitation, a description of one or more skills of the specific user (e.g., a current skill of the specific user, a skill that the specific user lacks, a skill predicted to be beneficial for the specific user to obtain, etc.), a description of a job history of the specific user, a description of a current job corresponding to the specific user, a description of one or more skills areas where the specific user is weak (according to a skills metric), a description of one or more learning courses completed by the specific user, and/or a description of how the specific user compares to a peer group.

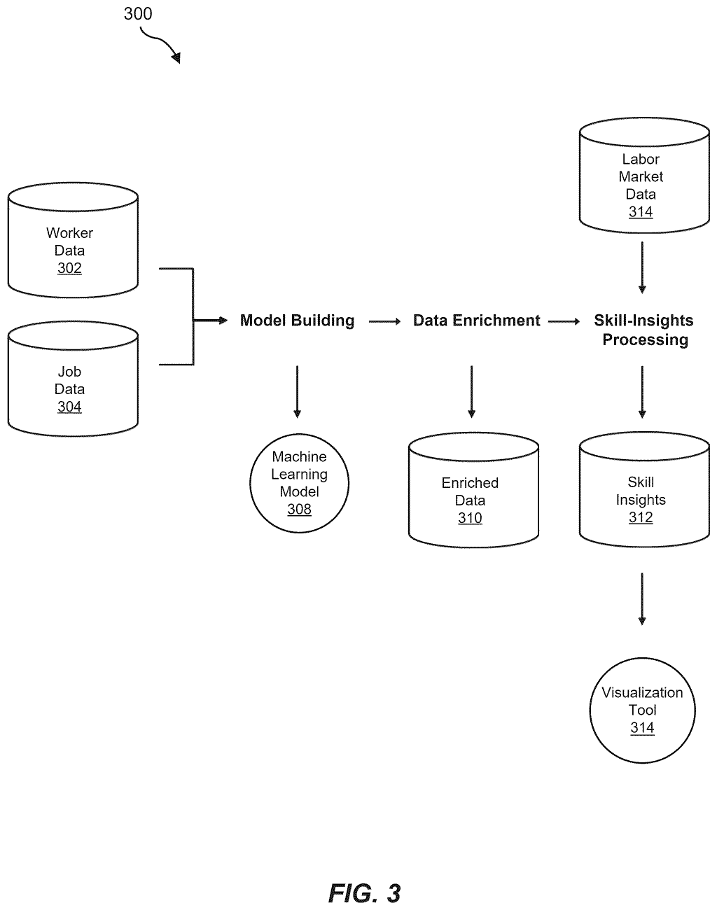

FIG. 3 depicts an exemplary data flow 300 corresponding to the systems and methods described herein. This exemplary data flow may be combined with any of the features described in connection with FIGS. 1 and 2. Data flow 300 begins by extracting data (e.g., worker data 302 and job data 304) from a third party. In some examples, worker data 302 may correspond to first natural language data 216 in FIG. 2, job data 304 may correspond to second natural language data 218 in FIG. 2, and/or the data extracting may correspond to steps 110 and/or 120 of FIG. 1. This extracted data may be used for a model building process to build a machine-learning model 308 (e.g., a machine-learning skills model). In some examples, machine-learning model 308 may correspond to first ML model 222 and/or second ML model 226 in FIG. 2. Machine-learning model 308 may be used for enriching data in a data enriching process, generating enriched data 310 (e.g., enriched worker data and/or enriched job data). The data enriching process may enrich the data in a variety of ways. For example, worker data 302 and/or job data 304 may be enriched by adding skills information to worker data 302 and/or job data 304. As another example, worker data 302 may be enriched by adding skills proficiency information to worker data 302. In some examples, the enriched worker data may correspond to augmented skills profiles 224, the enriched job data may correspond to augmented job postings 228, and/or the data enriching process may correspond to steps 130 and/or 140 of FIG. 1.

In some examples, enriched data 310 may be used in a skill-insights processing process to generate skill insights 312. In some examples, skill insights 312 may include skill and/or skill proficiency information (e.g., information added to and/or generated from worker data 302 and/or job data 304 as part of the data enriching process). In certain examples, the skill-insights processing process may also rely on labor market data 314 (e.g., corresponding to third natural language data 236 in FIG. 2). In one such example labor market data 314 may be enriched (e.g., via a machine learning model corresponding to fourth ML model 238 in FIG. 2) and this enriched data may be used in the skill-insights processing process. In some examples, enriching labor market data 314 may include adding skills information to labor market data 314. In examples in which the skill-insights processing process relies on labor market data 314 (and/or enriched labor market data), skill insights 312 may include a skill insight resulting from comparing enriched worker skill data and/or enriched job data with enriched labor market data. In some examples, skill insights 312 may correspond to output 234 in FIG. 2 and/or the skill-insights processing process may correspond to step 150 of FIG. 1.

In one embodiment, skill insights 312 may be transformed into a skill insights schema for analytics, which may be used to generate a skill analytics (e.g., skill visualization) tool 314 that presents a visualization of skill insights 312. An end-user (e.g., user 206 in FIG. 2) may then log into the skill analytics tool to view a visualization of one or more skill insights. In some examples, this visualization may correspond to visualization 232 in FIG. 2 and/or this visualization process may correspond to step 160 of FIG. 1.

In some examples, the disclosed framework (e.g., described in connection with FIGS. 1-3) may be described in two steps. In the first step, a customer skill model is generated from customer-specific data (e.g., first natural language data 216 and second language data 218). In the second step, the customer skill model (generated at the first step) is used to infer skills (e.g., from the first and second data) and/or for skills insights generation (e.g., to generate skill insights 312 in FIG. 3). In some examples, the customer skill model may be used in combination with a basic model (e.g., a model used across multiple customers that is not customized for a specific customer). Additionally or alternatively, the customer skill model may be generated using a basic model (e.g., a starting model that may be trained to generate the customer skill model). The customer skill model may correspond to one or more of the models of FIG. 2 (e.g., first ML model 222, second ML model 226, and/or third ML model 230) and/or may operate in conjunction with one or more of the models of FIG. 2.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device (e.g., memory devices 244, 246, and 248 in FIG. 2) and at least one physical processor (e.g., physical processors 250, 252, and 254 in FIG. 2).

The term “memory device” generally represents any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

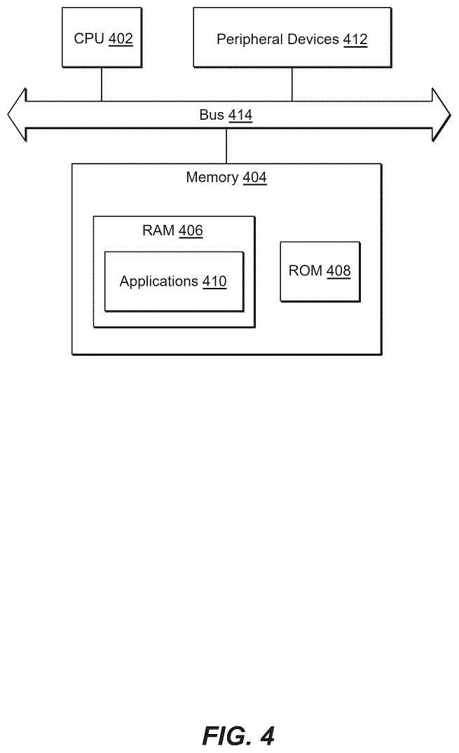

FIG. 4 is a block diagram of a computing device according to some embodiments of the disclosure.

As illustrated, the device includes a processor or central processing unit (CPU) such as CPU 402 in communication with a memory 404 via a bus 414. The device also includes one or more input/output (I/O) or peripheral devices 412. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 402 may comprise a general-purpose CPU. The CPU 402 may comprise a single-core or multiple-core CPU. The CPU 402 may comprise a system-on-a-chip (SoC) or a similar embedded system. In some embodiments, a graphics processing unit (GPU) may be used in place of, or in combination with, a CPU 402. Memory 404 may comprise a memory system including a dynamic random-access memory (DRAM), static random-access memory (SRAM), Flash (e.g., NAND Flash), or combinations thereof. In one embodiment, the bus 414 may comprise a Peripheral Component Interconnect Express (PCIe) bus. In some embodiments, the bus 614 may comprise multiple busses instead of a single bus.

Memory 404 illustrates an example of a non-transitory computer storage media for the storage of information such as computer-readable instructions, data structures, program modules, or other data. Memory 404 can store a basic input/output system (BIOS) in read-only memory (ROM), such as ROM 408 for controlling the low-level operation of the device. The memory can also store an operating system in random-access memory (RAM) for controlling the operation of the device.

Applications 410 may include computer-executable instructions which, when executed by the device, perform any of the methods (or portions of the methods) described previously in the description of the preceding figures. In some embodiments, the software or programs implementing the method embodiments can be read from a hard disk drive (not illustrated) and temporarily stored in RAM 406 by CPU 402. CPU 402 may then read the software or data from RAM 406, process them, and store them in RAM 406 again.

The device may optionally communicate with a base station (not shown) or directly with another computing device. One or more network interfaces in peripheral devices 412 are sometimes referred to as a transceiver, transceiving device, or network interface card (NIC).

An audio interface in peripheral devices 412 produces and receives audio signals such as the sound of a human voice. For example, an audio interface may be coupled to a speaker and microphone (not shown) to enable telecommunication with others or generate an audio acknowledgment for some action. Displays in peripheral devices 412 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 412 may comprise any input device arranged to receive input from a user. An illuminator in peripheral devices 412 may provide a status indication or provide light. The device can also comprise an input/output interface in peripheral devices 412 for communication with external devices, using communication technologies, such as USB, infrared, Bluetooth®, or the like. A haptic interface in peripheral devices 412 provides tactile feedback to a user of the client device.

A GPS receiver in peripheral devices 412 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The preceding detailed description is, therefore, not intended to be taken in a limiting sense.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may transform a processor, volatile memory, non-volatile memory, and/or any other portion of a physical computing device from one form to another by executing on the computing device, storing data on the computing device, and/or otherwise interacting with the computing device.

The term “computer-readable medium” may refer to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

Throughout the specification and claims, terms may have nuanced meanings suggested or implied in context beyond an explicitly stated meaning. Likewise, the phrase “in an embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense.

In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks.

In some alternate implementations, the functions or acts noted in the blocks can occur out of the order noted in the operational illustrations. For example, two blocks shown in succession can in fact be executed substantially concurrently or the blocks can sometimes be executed in the reverse order, depending upon the functionality or acts involved.

We claim:

1. A method comprising:
issuing, by a computing device, a query to a database;
receiving, at the computing device, a response to the query, the response including first natural language data comprising data associated with a plurality of users and second natural language data comprising textual data;
augmenting, by the computing device, the first natural language data using a first machine learning model to generate a set of augmented profiles for the plurality of users;
augmenting, by the computing device, the second natural language data using a second machine learning model to generate a set of augmented textual data;
generating, by the computing device, a difference between the set of augmented profiles and the set of augmented textual data using a third machine learning model; and
transmitting, by the computing device, a visualization of an output from the third machine learning model.

2. The method of claim 1, further comprising:
receiving, at the computing device, third natural language data comprising additional textual data;
augmenting, by the computing device, the third natural language data to generate an additional set of augmented textual data; and
generating, by the computing device using the third machine learning model, a difference between at least one of:
the set of augmented profiles and the additional set of augmented textual data; or
the set of augmented textual data and the additional set of augmented textual data.

3. The method of claim 1, wherein the first natural language data comprises at least one of:
a user job description;
user-generated content;
a description of a learning course completed by a user; or
a description of a project completed by a user.

4. The method of claim 1, further comprising extracting the first natural language data, by the computing device, from at least one of:
a digital user profile;
a digital user resume;
a digital user certificate;
a digital user record; or
a digital project record.

5. The method of claim 1, wherein the output comprises a semantic skills insight.

6. The method of claim 5, wherein the semantic skills insight comprises at least one of:
a semantic insight relating to a skill covered by a current workforce;
a semantic insight relating to a level of proficiency in a skill covered by the current workforce;
a semantic insight relating to a skills gap corresponding to a skill that is not covered by the current workforce;
a summary of skills corresponding to jobs being recruited via open job postings;
a summary of skills that the current workforce is losing via attrition;
a summary of how specific skills are represented in the current workforce;
a suggestion for transitioning the current workforce from a current set of skills to a new set of skills; or
a summary of skills-based industry hiring trends.

7. The method of claim 1, wherein:
the first natural language data comprises data associated with a specific user within the plurality of users; and
the output from the third machine learning model comprises a semantic insight relating to the specific user.

8. The method of claim 7, wherein the semantic insight relating to the specific user relates to at least one of:
one or more skills of the specific user;
a job history of the specific user;
a current job corresponding to the specific user;
one or more skills areas where the specific user is weak according to a skills metric; or
one or more learning courses completed by the specific user.

9. The method of claim 8, wherein the one or more skills of the specific user comprise at least one of:
a current skill of the specific user;
a skill that the specific user lacks; or
a skill predicted to be beneficial for the user to obtain.

10. The method of claim 1, further comprising generating the third machine learning model based on the first natural language data and the second natural language data.

11. A non-transitory computer-readable storage medium for tangibly storing computer program instructions capable of being executed by a computer processor, the computer program instructions defining steps of:
issuing a query to a database;
receiving a response to the query, the response including first natural language data comprising data associated with a plurality of users and second natural language data comprising textual data;
augmenting the first natural language data using a first machine learning model to generate a set of augmented profiles for the plurality of users;
augmenting the second natural language data using a second machine learning model to generate a set of augmented textual data;
generating a difference between the set of augmented profiles and the set of augmented textual data using a third machine learning model; and
transmitting a visualization of an output from the third machine learning model.

12. The non-transitory computer-readable storage medium of claim 11, the computer program instructions further defining steps of:
receiving third natural language data comprising additional textual data;
augmenting the third natural language data to generate an additional set of augmented textual data; and
generating a difference between at least one of:
the set of augmented profiles and the additional set of augmented textual data; or
the set of augmented textual data and the additional set of augmented textual data.

13. The non-transitory computer-readable storage medium of claim 11, wherein the first natural language data comprises at least one of:
a user job description;
user-generated content;
a description of a learning course completed by a user; or
a description of a project completed by a user.

14. The non-transitory computer-readable storage medium of claim 11, the computer program instructions further defining steps of extracting the first natural language data from at least one of:
a digital user profile;
a digital user resume;
a digital user certificate;
a digital user record; or
a digital project record.

15. The non-transitory computer-readable storage medium of claim 11, wherein the output comprises a semantic skills insight.

16. The non-transitory computer-readable storage medium of claim 15, wherein the semantic skills insight comprises at least one of:
a semantic insight relating to a skill covered by a current workforce;
a semantic insight relating to a level of proficiency in a skill covered by the current workforce;
a semantic insight relating to a skills gap corresponding to a skill that is not covered by the current workforce;
a summary of skills corresponding to jobs being recruited via open job postings;
a summary of skills that the current workforce is losing via attrition;
a summary of how specific skills are represented in the current workforce;
a suggestion for transitioning the current workforce from a current set of skills to a new set of skills; or
a summary of skills-based industry hiring trends.

17. The non-transitory computer-readable storage medium of claim 11, wherein:
the first natural language data comprises data associated with a specific user within the plurality of users; and
the output from the third machine learning model comprises a semantic insight relating to the specific user.

18. The non-transitory computer-readable storage medium of claim 17, wherein the semantic insight relating to the specific user relates to at least one of:
one or more skills of the specific user;
a job history of the specific user;
a current job corresponding to the specific user;
one or more skills areas where the specific user is weak according to a skills metric; or
one or more learning courses completed by the specific user.

19. The non-transitory computer-readable storage medium of claim 18, wherein the one or more skills of the specific user comprise at least one of:
a current skill of the specific user;
a skill that the specific user lacks; or
a skill predicted to be beneficial for the user to obtain.

20. A device comprising:
a processor; and
a storage medium for tangibly storing thereon program logic for execution by the processor, the program logic comprising:
logic, executed by the processor, for issuing a query to a database,
logic, executed by the processor, for receiving a response to the query, the response including first natural language data comprising data associated with a plurality of users and second natural language data comprising textual data,
logic, executed by the processor, for augmenting the first natural language data using a first machine learning model to generate a set of augmented profiles for the plurality of users,
logic, executed by the processor, for augmenting the second natural language data using a second machine learning model to generate a set of augmented textual data;
logic, executed by the processor, for generating a difference between the set of augmented profiles and the set of augmented textual data using a third machine learning model; and
logic, executed by the processor, for transmitting a visualization of an output from the third machine learning model.
